(19) United States
(12) Patent Application Publication
(10) Pub. No.: US 2017/0219738 A1
(43) Pub. Date: Aug. 3, 2017

(54) METHOD FOR QUANTITATIVELY EVALUATING THE ANISOTROPY OF ROUGHNESS COEFFICIENT OF ROCK JOINTS

(71) Applicant: SHAOXING UNIVERSITY, Shaoxing (CN)

(72) Inventors: SHIGUI DU, SHAOXING (CN); RUI YONG, SHAOXING (CN); JUN YE, SHAOXING (CN); XI FU, SHAOXING (CN); CHENGRONG MA, SHAOXING (CN); QIFENG LIANG, SHAOXING (CN); BO LI, SHAOXING (CN); MAN HUANG, SHAOXING (CN)

(73) Assignee: SHAOXING UNIVERSITY

(21) Appl. No.: 15/340,891

(22) Filed: Nov. 1, 2016

(30) Foreign Application Priority Data
Feb. 1, 2016 (CN) 201610072331.5

(51) Int. Cl. G01V 99/00; G01B 21/30

(52) U.S. Cl. CPC G01V 99/005; G01B 21/30

(57) ABSTRACT

A method for quantitatively evaluating the anisotropy of joint roughness coefficient of rock joints is provided, comprising the following steps: selecting a joint sample of an engineering rock mass to be analyzed; uniformly arranging rock joint measurement segments in different orientations; recording each joint profile by a profilograph;

measuring joint roughness coefficient of each measurement segment; calculating a statistical mean value of the joint roughness coefficients in each orientation under same dimensional conditions, and obtaining a roughness coefficient class ratio in each orientation; transforming each item in the roughness coefficient class ratio by R₁(i)=r₀(i)^{1/m}; fitting the processed roughness coefficient of the rock joints by anisotropic ellipse function; determining a major axis a and a minor axis b of the anisotropic ellipse, Θ representing a direction of rotation, where a ratio of the major axis to the minor axis indicates a difference between the maximum roughness coefficient and the minimum roughness coefficient on the anisotropic ellipse, and Θ indicates a dominant orientation for roughness development of the rock joints. The present invention can effectively and quantitatively determine the degree of the anisotropy of joint roughness coefficient of the rock joints.

### TECHNICAL FIELD OF THE INVENTION

The present invention relates to a method for evaluating the anisotropy of joint roughness coefficients (JRC) for natural rock joint samples. Particularly, in the present invention, the joint roughness coefficients in different orientations are transformed by the class ratio method, and the class ratio value can be used to represent the non-uniformity of the distribution of joint roughness coefficients. The ellipse function is applied to fit the transformed data for determining the dominant orientation of the joint roughness coefficients. By doing so, the quantitative evaluation on the anisotropy of joint roughness coefficient of the rock joints of the rock mass is achieved. The present invention belongs to the technical field in engineering.

### BACKGROUND OF THE INVENTION

Anisotropy is one of the essential features of rock joints. The roughness anisotropy of the rock joints determines the contact degree of upper and lower joints. Furthermore, it also influences the shear strength of the rock joints, and the hydraulic permeation and conduction mechanism inside the rock joints. To date, in order to study the roughness anisotropy feature of a rock joint, the differences of the joint roughness in each orientation are generally indicated by the joint roughness coefficients of joint profiles measured in different orientations. Before illustrating the present invention, a brief literature review about the previous studies on the joint roughness anisotropy in China is described as follows:

(1) In 1993, DU Shigui and TANG Huiming systemically studied the roughness coefficients of different rock joints through the anisotropy rules and the scale effects of the roughness coefficients. According to the results of qualitative analysis of surface morphologies fractured due to different causes and in combination of 2180 statistical results of the measured values of roughness coefficients in different orientation.

(2) In 1994, based on the classification of rock joints fracture mechanics and in a combination of the roughness coefficient tests and indoor rock joints straight-shear experiments for the rock joints surfaces in different lengths and different orientations, LI Jiulin and TANG Huiming summarized that the roughness and shear strength of a rock joints had anisotropic characteristics.

(3) In 2006, DU Shigui, et al. proposed a method for evaluating the shear strength of the rock joints according to the shear strength of the rock joints in a direct shear test orientation.

(4) In 2015, on the basis of the analysis on the essential geological characteristics of rock joints via the geostatistics method, CHEN Shijiang, et al. proposed a method for representing the roughness of rock joints by using variation function parameters, calculating roughness values in 32 orientations within different dimensional ranges on the rock joints by the proposed formula, and analyzing the roughness anisotropy of the rock joints and the scale effect characteristics.

Among these methods, the irregularity of parameters in each orientation is visually represented by an anisotropy graph, the dominant orientation of the roughness of the rock joints is determined by observation, and the difference in roughness of the rock joints in each orientation is determined by the smoothness of lines in the anisotropy graph. However, it is difficult to quantitatively determine the degree of anisotropy of roughness coefficient of a rock joint by these methods.

### SUMMARY OF THE INVENTION

To overcome the shortcoming in the existing evaluation methods that the anisotropy of joint roughness coefficient cannot be quantitatively determined, the present invention provides an effective method for quantitatively evaluating the anisotropy of joint roughness coefficient.

To solve the technical problem, the present invention employs the following technical solutions.

A method for quantitatively evaluating the anisotropy of joint roughness coefficient is provided, comprising the following steps:

(1) selecting a joint sample of an engineering rock mass to be analyzed;

(2) equally arranging rock joint measurement segments in different orientations;

(3) drawing each joint profile by a profilograph;

(4) extracting coordinate data on the profile curve by an image processing method, so as to measure a roughness coefficient of the rock joints in each measurement segments;

(5) calculating a statistical mean value of the roughness coefficients of the rock joints in each orientation under same dimensional conditions, and obtaining a roughness coefficient class ratio r₀=(r₀(1),r₀(2), . . . , r₀(t))in each orientation, where t represents the number of measurement orientations, r₀(1) is a roughness coefficient in the first measurement orientation, r₀(2) is a roughness coefficient in the second measurement orientation, and r₀(t) is a roughness coefficient in the t^{th} orientation;

(6) transforming each item in the roughness coefficient class ratio by using R₁(i)=r₀(i)^{1/m} until

$$J = [ \frac{{R}_{0} ( 1 )}{{R}_{0} ( 2 )} , \frac{{R}_{0} ( 2 )}{{R}_{0} ( 3 )} , … , \frac{{R}_{0} ( t - 1 )}{{R}_{0} ( t )} ]$$

meets J∈[e^{-2/(t+1)},e^{2/(t+1)}], where m≧ and m is an exponential term, r₀(i) represents a roughness coefficient in the i^{th} orientation, R₁(i) represents a transformed value of the roughness coefficient in the i^{th} orientation, wherein the value of m is denoted by m₀, m₀ representing the smoothness of the roughness coefficient of the rock joints in each orientation and called a roughness smooth coefficient;

(7) fitting the processed roughness coefficient R₀=(R₀(1),R₀(2), . . . , R₀(t)) of the rock joints by using an anisotropic ellipse:

Ax²+Bxy+Cy²+Dx+Ey+F=0

where x=R₀ cos θ, y=R₀ sin θ, θ represents a measurement orientation, and A, B, C, D, E and F all are elliptic coefficients;

(8) determining a major axis a and a minor axis b of the anisotropic ellipse by the following formula, Θ representing a direction of rotation:

$$\{ \begin{matrix}{{a}^{2} ( sin Θ )}^{2} + {{b}^{2} ( cos Θ )}^{2} - A = 0 \\ 2 ( {b}^{2} - {a}^{2} ) sin Θ cos Θ - B = 0 \\ {{a}^{2} ( cos Θ )}^{2} + {{b}^{2} ( sin Θ )}^{2} - C = 0 \\ 2 {Ax}_{c} + {By}_{c} + D = 0 \\ {Bx}_{c} + 2 {Cy}_{c} + E = 0\end{matrix} .$$

where a ratio of the major axis to the minor axis indicates a difference between the maximum roughness coefficient and the minimum roughness coefficient on the anisotropic ellipse, and Θ indicates a dominant orientation for roughness development of the rock joints.

The present invention mainly has the following beneficial effect: the degree of the anisotropy of joint roughness coefficient of rock joints is determined effectively and quantitatively.

### BRIEF DESCRIPTION OF THE DRAWINGS

FIG. 1 is a diagram of the anisotropy of joint roughness coefficient;

FIG. 2 is a diagram of the anisotropy of joint roughness coefficient when a class ratio transform coefficient m is 3, i.e., m=3;

FIG. 3 is a diagram of the anisotropy of joint roughness coefficient when the class ratio transform coefficient m is 5, m=5; and

FIG. 4 is a diagram of the anisotropy of joint roughness coefficient after the roughness smooth coefficient transform, and the anisotropic ellipse fitting.

### DETAILED DESCRIPTION OF THE INVENTION

The present invention will be further described with reference to the accompanying drawings.

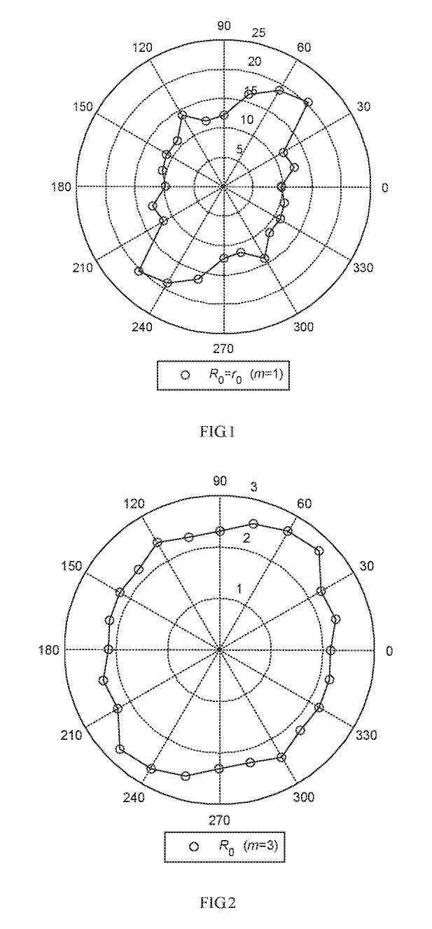

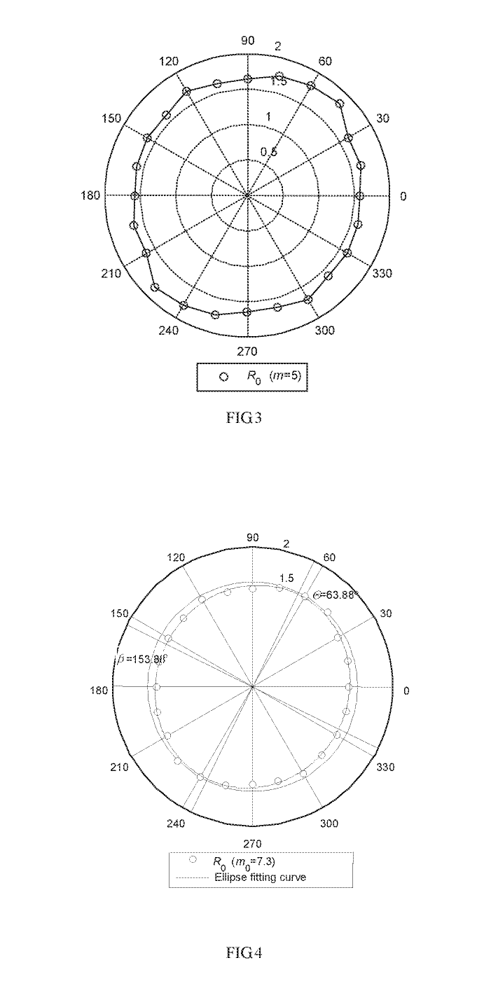

With reference to FIGS. 1-4, a method for quantitatively evaluating the anisotropy of joint roughness coefficient of rock joints is provided, comprising the following steps of:

(1) selecting a joint sample of an engineering rock mass to be analyzed, and determining a potential slip orientation;

(2) uniformly arranging rock joint measurement segments in different orientations;

(3) drawing each joint profile by a profilograph;

(4) extracting coordinate data on the profile curve by an image processing method, so as to measure a roughness coefficient of the rock joints in each of the measurement segments;

(5) calculating a statistical mean value of the roughness coefficients of the rock joints in each orientation under same dimensional conditions, and obtaining a roughness coefficient class ratio r₀=(r₀(1),r₀(2) , . . . , r₀(t)) in each orientation, where t represents the number of measurement orientations, r₀(1) is a roughness coefficient in the first measurement orientation, r₀(2) is a roughness coefficient in the second measurement orientation, and r₀(t) is a roughness coefficient in the t^{th} orientation;

(6) transforming each item in the roughness coefficient class ratio by using R₁(i)=r₀(i)^{1/m} until

$$J = [ \frac{{R}_{0} ( 1 )}{{R}_{0} ( 2 )} , \frac{{R}_{0} ( 2 )}{{R}_{0} ( 3 )} , … , \frac{{R}_{0} ( t - 1 )}{{R}_{0} ( t )} ]$$

meets J∈[e^{-2/(t+1)}, e^{2/(t+1)}], where m≦ and m is an exponential term, r₀(i) represents a roughness coefficient in the i^{th} orientation, r₀(i) represents a transformed value of the roughness coefficient in the i^{th} orientation, wherein the value of m is denoted by m₀, m₀ representing the smoothness of the roughness coefficient of the rock joints in each orientation and called a roughness smooth coefficient, this parameter reflecting a difference between roughness coefficients of the rock joints in different orientations;

(7) fitting the processed roughness coefficient R₀=(R₀(1), R₀(2), . . . , R₀(t)) of the rock joints by using an anisotropic ellipse:

Ax²+Bxy+Cy²+Dx+Ey+F=0

where x=R₀ cos θ, y=R₀ sin θ,θ represents a measurement orientation, and A, B, C, D, E and F all are elliptic coefficients;

(8) determining a major axis a and a minor axis b of the anisotropic ellipse by the following formula, Θ representing a direction of rotation:

$$\{ \begin{matrix}{{a}^{2} ( sin Θ )}^{2} + {{b}^{2} ( cos Θ )}^{2} - A = 0 \\ 2 ( {b}^{2} - {a}^{2} ) sin Θ cos Θ - B = 0 \\ {{a}^{2} ( cos Θ )}^{2} + {{b}^{2} ( sin Θ )}^{2} - C = 0 \\ 2 {Ax}_{c} + {By}_{c} + D = 0 \\ {Bx}_{c} + 2 {Cy}_{c} + E = 0\end{matrix} .$$

where a ratio of the major axis to the minor axis indicates a difference between the maximum roughness coefficient and the minimum roughness coefficient on the anisotropic ellipse, and Θ indicates a dominant orientation for roughness development of the rock joints.

An embodiment: A method for quantitatively evaluating the anisotropy of roughness coefficient of rock joints is provided. The process is as follows.

First, a representative granite rock joint is measured in the field. The roughness coefficients of the rock joints measured in different orientations are as shown in Table 1, and the anisotropy graph is shown in FIG. 1. In this case, the value of m is 0.

TABLE 1

| Measurement orientation | JRC |
|---|---|
| 0 | 9.818 |
| 15 | 12.471 |
| 30 | 11.688 |
| 45 | 20.395 |
| 60 | 18.865 |
| 75 | 16.306 |
| 90 | 12.212 |
| 105 | 11.652 |
| 120 | 14.051 |
| 135 | 10.955 |
| 150 | 11.071 |
| 165 | 10.737 |
| 180 | 9.818 |
| 195 | 12.471 |
| 210 | 11.688 |
| 225 | 20.395 |
| 240 | 18.865 |
| 255 | 16.306 |
| 270 | 12.212 |
| 285 | 11.652 |
| 300 | 14.051 |
| 315 | 10.955 |
| 330 | 11.071 |
| 345 | 10.737 |
| 360 | 9.818 |

Second, due to the large difference in the roughness coefficient in each orientation, the fitting may not be directly performed by an elliptic equation, and in this case, the experimental data will be processed by class ratio analysis. When the values of m are 3 and 5, respectively, the difference in the processed roughness coefficients in each orientation is reduced significantly, and the irregular shape gradually tends to an elliptic shape. However, the conditions of the class ratio analysis are not met. Accordingly, it is required to continuously increase the value of m.

Then, when the value of m is 7.3, the processed roughness coefficients meet the conditions of the class ratio analysis. In other words, m₀₌7.3 is a roughness smooth coefficient of the rock joints, and may be used for representing the anisotropy of the joint roughness coefficient.

Finally, in accordance with the anisotropy elliptic equation, it can be obtained that a ratio of the major axis to the minor axis is 1.045, and the dominant orientation of the roughness coefficient of the rock joints is 63.88°.

1. A method for quantitatively evaluating the anisotropy of joint roughness coefficient of natural rock joint samples, comprising the following steps of:
(1) selecting a joint sample of an engineering rock mass to be analyzed;
(2) uniformly arranging rock joint measurement segments in different orientations;
(3) drawing each joint profile by a profilograph;
(4) extracting coordinate data on the profile curve by an image processing method, so as to measure a roughness coefficient of the rock joints in each of the measurement segments;
(5) calculating a statistical mean value of the roughness coefficients of the rock joints in each orientation under same dimensional conditions, and obtaining a roughness coefficient class ratio r₀(r₀(1), r₀(2), . . . , r₀(t)) in each orientation, where t represents the number of measurement orientations, r₀(1) is a roughness coefficient in the first measurement orientation, r₀(2) is a roughness coefficient in the second measurement orientation, and r₀(t) is a roughness coefficient in the t^{th} orientation;
(6) transforming each item in the roughness coefficient class ratio by using
R₁(i)=r₀(i)^{1/m} until
$$J = [ \frac{{R}_{0} ( 1 )}{{R}_{0} ( 2 )} , \frac{{R}_{0} ( 2 )}{{R}_{0} ( 3 )} , … , \frac{{R}_{0} ( t - 1 )}{{R}_{0} ( t )} ]$$
meets J∈[e^{-2/(t+1)},e^{2/(t+1)}], where m≧1 and m is an exponential term, r₀(i) represents a roughness coefficient in the i^{th} orientation, R₀(i) represents a transformed value of the roughness coefficient in the i^{th} orientation, wherein the value of m is denoted by m₀, m₀ representing the smoothness of the roughness coefficient of the rock joints in each orientation and called a roughness smooth coefficient;
(7) fitting the processed roughness coefficient R₀(R₀(1), R₀(2), . . . , R₀(t)) of the rock joints by using an anisotropic ellipse:
Ax²+Bxy+Cy²+Dx+Ey+F=0
where x=R₀ cos θ, y=R₀ sin θ, θ represents a measurement orientation, and A, B, C, D, E and F all are elliptic coefficients;
(8) determining a major axis a and a minor axis b of the anisotropic ellipse by the following formula, Θ representing a direction of rotation:
$$\{ \begin{matrix}{{a}^{2} ( sin Θ )}^{2} + {{b}^{2} ( cos Θ )}^{2} - A = 0 \\ 2 ( {b}^{2} - {a}^{2} ) sin Θ cos Θ - B = 0 \\ {{a}^{2} ( cos Θ )}^{2} + {{b}^{2} ( sin Θ )}^{2} - C = 0 \\ 2 {Ax}_{c} + {By}_{c} + D = 0 \\ {Bx}_{c} + 2 {Cy}_{c} + E = 0\end{matrix} .$$
where a ratio of the major axis to the minor axis indicates a difference between the maximum roughness coefficient and the minimum roughness coefficient on the anisotropic ellipse, and Θ indicates a dominant orientation for roughness development of the rock joints.
